(19) United States
(12) Patent Application Publication
(10) Pub. No.: US 2008/0060067 A1
(43) Pub. Date: Mar. 6, 2008

(54) Ip management Method and Apparatus for Protecting/Blocking Specific Ip Address or Specific Device on Network

(75) Inventors: Chanwoo Kim, Seoul (KR); Seonghyo Shin, Gyeonggi-do (KR)

Correspondence Address: LAHIVE & COCKFIELD, LLP, ONE POST OFFICE SQUARE, BOSTON, MA, 02109-2127, US

(73) Assignee: SCOPE INC., Gangnam-gu (KR)

(21) Appl. No.: 11/667,507

(22) PCT Filed: Nov. 28, 2005
(86) PCT No.: PCT/KR05/04024

§ 371 Date: May 10, 2007

(30) Foreign Application Priority Data
Apr. 6, 2005 (KR) 10-2005-002876

(51) Int. Cl. H04L 9/32

(52) U.S. Cl. 726/7

(57) ABSTRACT

Disclosed is an IP management method for protecting a specific IP address on a network, which including the steps of: (a) detecting an ARP packet transmitted on the network; (b) extracting a sender address from the ARP packet; (c) determining if a transmission IP address of the sender address has been set as a protection IP; (d) when the transmission IP address has been set as the protection IP, determining if a transmission MAC address of the sender address is equal to a designated MAC address capable of using the transmission IP address; (e) when the transmission MAC address is different from the designated MAC address, transmitting an ARP packet to the sender address; and (f) transmitting a compensation packet to all devices on the network, wherein the compensation packet allows an actually used MAC address of the transmission IP address to be equal to the designated MAC address.

### TECHNICAL FIELD

The present invention relates to a method and an apparatus for managing an Internet Protocol (hereinafter, referred to as IP) in order to protect/block a specific IP address or a specific device on a network. More particularly, the present invention relates to a method and an apparatus for managing an IP in order to protect/block a specific IP address or a specific device on a network, in which, whenever a network Address Resolution Protocol (hereinafter, referred to as ARP) packet is collected in an internal network management system based on an IP and a Media Access Control (hereinafter, referred to as MAC), correlation between a protection IP and an MAC is determined, an MAC, which is prohibited from accessing to the system, is blocked from accessing the system in order to protect the IP, an ARP packet including manipulated MAC information is provided to unauthorized (blocked) devices in order to block communication, and packets are not allowed to be outputted from the blocked devices to a main device, so that it is possible to reduce network traffic introduced to the main device.

### BACKGROUND ART

As an information-oriented society is gradually realized with the development of information communication technology, the Internet has become an important and necessary medium in all fields including society, culture, economy, etc. Further, since all businesses within a company are processed through the Intranet, network management has been recognized as a very important issue. Generally, network management may be classified as configuration management, failure management, performance management, security management, accounting management, automatic analysis, etc. To this end, various network management protocols have been established and recommended by an international standardization body, and a plurality of IP-based network management systems have also been developed.

Herein, the IP-based network management system provides a method for managing resources and monitoring a network, and enables network resources (e.g. PCs, routers, printers, various servers) to be efficiently managed, and security control for users to be performed in the Intranet environment. The basic concept of the IP-based network management system lies in that a manager of a specific network establishes communication control rules by means of a management device connected at the same level to other devices of the network, and forcedly applies the established communication control rules to communication among the devices within the network, so that it is possible to limit communication within the network according to the communication control rules.

As the number of users of an ultra high speed Internet rapidly increases with the increase in network use, network traffic is also increasing. Such increase in network traffic may cause deterioration of service quality. Accordingly, it is necessary to provide a more efficient IP management system.

Generally, almost all companies have important servers/devices, and all of these devices have network functions. For example, in the case of a web server, the domain name and IP of the server have been registered in a DNS. Herein, if other PCs within the company use the corresponding IP in a state where the web server is powered off, the web server cannot use its own IP even after the web server is powered on. This is based on a general IP preoccupation rule by which an already used IP cannot be simultaneously used according to the basic operation of an operation system. In such a case, a general external user cannot use the web server. Accordingly, it is necessary to regard a main apparatus as an exception of the general IP preoccupation rules and protect the IP of the main apparatus.

Further, when network failure has occurred or viruses, etc., have occurred, problems occurring in specific main devices including servers and DBs may have fatal influence on an entire system. Accordingly, the demand for efficiently protecting an IP on a network is also increasing.

### DISCLOSURE OF THE INVENTION

Therefore, the present invention has been made in view of the above-mentioned problems, and it is an object of the present invention to provide a method and an apparatus for managing an IP in order to protect/block a specific IP address or a specific device on a network, in which, whenever a network ARP packet is collected in an internal network management system based on an IP and an MAC, correlation between a protection IP and an MAC is determined, an MAC, which is prohibited from accessing to the system, is blocked from accessing the system in order to protect the IP, an ARP packet including manipulated MAC information is provided to unauthorized (blocked) devices in order to block communication, and packets are not allowed to be outputted from the blocked devices to a main device, so that it is possible to reduce network traffic introduced to the main device.

According to one aspect of the present invention, there is provided an Internet Protocol (IP) management method for protecting a specific IP address on a network, the method including the steps of: (a) detecting an Address Resolution Protocol (ARP) packet transmitted on the network; (b) extracting a sender address from the ARP packet; (c) determining if a transmission IP address of the sender address has been set as a protection IP; (d) when the transmission IP address has been set as the protection IP, determining if a transmission Media Access Control (MAC) address of the sender address is equal to a designated MAC address capable of using the transmission IP address; (e) when the transmission MAC address is different from the designated MAC address, transmitting an ARP packet, in which the transmission IP address is manipulated as having been already used, to the sender address; and (f) transmitting a compensation packet to all devices on the network, wherein the compensation packet allows an actually used MAC address of the transmission IP address to be equal to the designated MAC address.

According to another aspect of the present invention, there is provided an IP management method for protecting a specific device having a specific IP address on a network, the method including the steps of: (a) detecting an ARP packet transmitted on the network; (b) extracting a sender address and/or a receiver address from the ARP packet; (c) determining if a sender is an object to be blocked, transmitting a blocking packet, in which a transmission MAC address of the sender has been manipulated, in a broadcast manner when the sender is the object to be blocked; and (d) transmitting a blocking packet, in which a reception MAC address of the receiver address has been manipulated, to the sender address in a unicast manner.

According to further another aspect of the present invention, there is provided an IP management method blocking a specific device having a specific IP address on a network, and blocking transmission to a main device designated by a manager, the method including the steps of: (a) detecting an ARP packet transmitted on the network; (b) extracting a sender address and/or a receiver address from the ARP packet; (c) determining if a sender is an object to be blocked, transmitting a blocking packet, in which a transmission MAC address of the sender has been manipulated, in a broadcast manner when the sender is the object to be blocked; and (d) determining if a receiver is a main device, and transmitting a blocking packet, in which a reception MAC address of the receiver address has been manipulated, to the sender address in a unicast manner when the receiver is the main device.

According to yet another aspect of the present invention, there is provided an IP management apparatus for protecting a specific IP address on a network, the apparatus including: a packet detector for detecting an ARP packet transmitted on the network; and a packet controller for extracting a sender address from the ARP packet, determining if a transmission IP address of the sender address has been set as a protection IP, determining if a transmission MAC address of the sender address is equal to a designated MAC address capable of using the transmission IP address when the transmission IP address has been set as the protection IP, transmitting an ARP packet, in which the transmission IP address is manipulated as having been already used, to the sender address when the transmission MAC address is different from the designated MAC address, and transmitting a compensation packet to all devices on the network, wherein the compensation packet allows an actually used MAC address of the transmission IP address to be equal to the designated MAC address.

According to still another aspect of the present invention, there is provided an IP management apparatus for blocking a specific device having a specific IP address on a network, the apparatus including: a packet detector detecting an ARP packet transmitted on the network; and a packet controller for extracting a sender address and/or a receiver address from the ARP packet, determining if a sender is an object to be blocked, transmitting a blocking packet, in which a transmission MAC address of the sender has been manipulated, in a broadcast manner when the sender is the object to be blocked, transmitting a blocking packet, in which a reception MAC address of the receiver address has been manipulated, to the sender address in a unicast manner, determining if a receiver is an object to be blocked, transmitting a blocking packet, in which a reception MAC address of the receiver has been manipulated, in a broadcast/unicast manner when the receiver is the object to be blocked, and transmitting a blocking packet, in which the transmission MAC address of the sender address has been manipulated, to the receiver address in a unicast manner.

According to still another aspect of the present invention, there is provided an IP management apparatus blocking a specific device having a specific IP address on a network, and blocking transmission to a main device designated by a manager, the apparatus including: a packet detector detecting an ARP packet transmitted on the network; and a packet controller for extracting a sender address and/or a receiver address from the ARP packet, determining if a sender is an object to be blocked, transmitting a blocking packet, in which a transmission MAC address of the sender has been manipulated, in a broadcast manner when the sender is the object to be blocked, determining if a receiver is a main device, transmitting a blocking packet, in which a reception MAC address of the receiver address has been manipulated, to the sender address in a unicast manner when the receiver is the main device, determining if the receiver is an object to be blocked, transmitting a blocking packet, in which the reception MAC address of the receiver address has been manipulated, in a broadcast/unicast manner when the receiver is the object to be blocked, and determining if the sender is the main device, transmitting a blocking packet, in which the transmission MAC address of the sender address has been manipulated, to all blocked devices on the network in a unicast manner when the sender is the main device.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram schematically illustrating the construction of an IP management system for protecting/blocking a specific IP address or a specific device on a network according to a preferred embodiment of the present invention;

FIG. 2 is a block diagram schematically illustrating the internal construction of an IP management device according to a preferred embodiment of the present invention;

FIG. 3 is a diagram illustrating the configuration of an ARP packet;

FIG. 4 is a flow diagram illustrating an IP management process for protecting a specific IP address on a network according to a first preferred embodiment of the present invention;

FIG. 5 is a flow diagram illustrating an IP management process for blocking a specific device having a specific IP address on a network according to a second preferred embodiment of the present invention; and

FIG. 6 is a flow diagram illustrating an IP management process for blocking a specific device having a specific IP address on a network, and blocking transmission to a main device designated by a manager according to a third preferred embodiment of the present invention.

### BEST MODE FOR CARRYING OUT THE INVENTION

Reference will now be made in detail to the preferred embodiment of the present invention. It should be noted that the similar components are designated by similar reference numerals although they are illustrated in different drawings. Also, in the following description, a detailed description of known functions and configurations incorporated herein will be omitted when it may obscure the subject matter of the present invention.

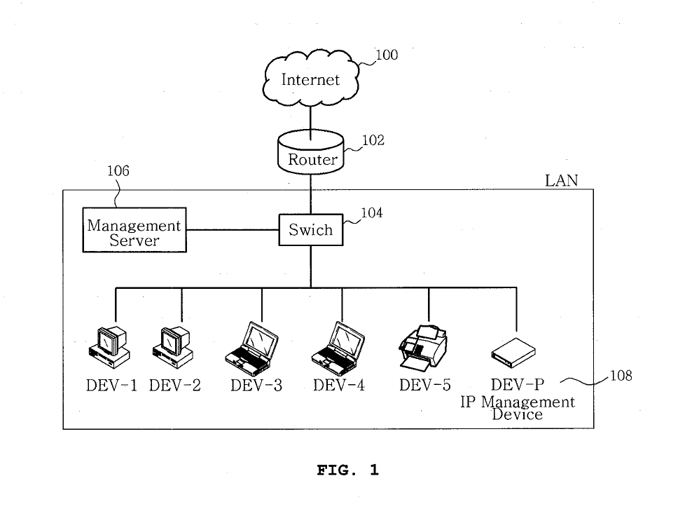

FIG. 1 is a block diagram schematically illustrating the construction of an IP management system for protecting/blocking a specific IP address or a specific device on a network according to a preferred embodiment of the present invention.

As illustrated in FIG. 1, the IP management system according to the preferred embodiment of the present invention includes the Internet 100, a router 102, a switch 104, a management server 106, an IP management device 108, a plurality of devices DEV-1 to DEV-5, etc.

The switch 104, the management server 106, the IP management device 108 and the devices DEV-1 to DEV-5 are connected to one another through a Local Area Network (hereinafter, referred to as LAN). Herein, communication among resources connected to a specific network such as the LAN is performed by means of an Address Resolution Protocol (hereinafter, referred to as ARP) . The ARP is a protocol used in order to allow a network layer address, e.g. a protocol layer L3 address, to correspond to a physical address, e.g. a data link L2 address. Herein, the physical address represents a 48-bit network card address, etc., of an Ethernet or a token ring. An ARP packet is included in Ethernet packet data. The header of an Ethernet packet includes a destination Ethernet address (48 bits), a sender Ethernet address (48 bits) and an Ethernet protocol type (16 bits). The ARP packet is attached after such an Ethernet packet header. When a packet moves on a LAN, the packet is transmitted to a destination Ethernet address, e.g. an MAC address.

For example, when an IP host A attempts to transmit an IP packet to an IP host B, if the IP host A does not know the physical address of the IP host B, the IP host A transmits an ARP request packet to a network by means of an ARP protocol, wherein the ARP request packet includes the IP address of the IP host B, which is a destination, and information on a broadcasting physical address FF:FF:FF:FF:FF:FF. If the IP host B receives the ARP packet in which the address of the IP host B has been recorded as a destination, the IP host B transmits its own physical network layer address to the IP host A. The collected IP address and physical network layer address information corresponding to the IP address are stored in a memory, which is referred to as an ARP cache, as an ARP table, and then are used again when a subsequent packet is transmitted. In this way, internal communication is performed among the resources, which are connected to a network such as the LAN, by means of the method as described above.

The IP management device 108 according to the preferred embodiment of the present invention is a single node connected to the LAN in a LAN environment, in which the devices DEV-1 to DEV-5 according to the preferred embodiment of the present invention are connected through the layer 2 switch 104. That is, the IP management device 108 is connected at the same level with the devices DEV-1 to DEV-5. The IP management device 108 according to the preferred embodiment of the present invention processes the afore-described ARP table in order to control communication for a desired device, thereby freely controlling communication among the devices within the LAN. The IP management device 108 for performing such a function will be described in detail later.

The LAN according to the preferred embodiment of the present invention may also be connected to the router 102, the Internet 100, another network, e.g. Virtual LAN (VLAN), etc.

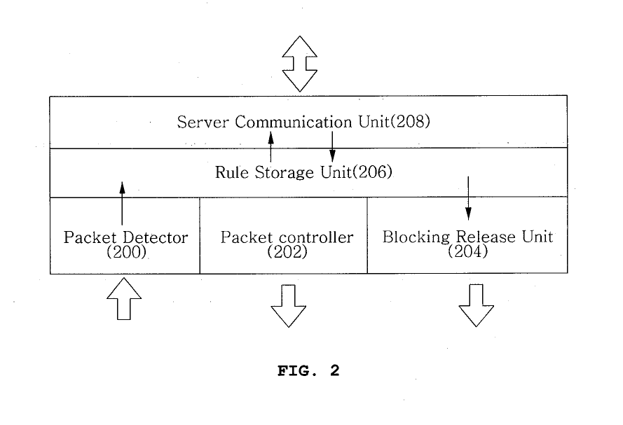

FIG. 2 is a block diagram schematically illustrating the internal construction of the IP management device according to the preferred embodiment of the present invention.

The IP management device 108 according to the preferred embodiment of the present invention includes a packet detector 200, a packet controller 202, a blocking release unit 204, a rule storage unit 206, a server communication unit 208, etc.

The packet detector 200 according to the preferred embodiment of the present invention detects an ARP packet transmitted on a network, the packet controller 202 performs a blocking/releasing/monitoring operation etc., the blocking release unit 204 releases devices blocked by the packet controller 202, the rule storage unit 206 establishes control rules for managing devices within a network, and the server communication unit 208 performs a communication function with the management server 106.

For description about the operation of the IP management device 108 according to the preferred embodiment of the present invention, an operation when a certain communication device starts networking will be described based on an ARP.

As illustrated in FIG. 1, it is assumed that five devices DEV-1 to DEV-5 and the IP management device 108 according to the preferred embodiment of the present invention exist in the same LAN, and the ARP caches of all devices are empty. Table 1 below shows an example of IP addresses and MAC addresses according to the devices.

TABLE 1

| Device name | IP address | MAC address | Power state |
|---|---|---|---|
| DEV-1 | IP-1 | MAC-1 | ON |
| DEV-2 | IP-2 | MAC-2 | ON |
| DEV-3 | IP-3 | MAC-3 | ON |
| DEV-4 | IP-4 | MAC-4 | ON |
| DEV-5 | IP-5 | MAC-5 | OFF |
| DEV-P | IP-P | MAC-p | ON |

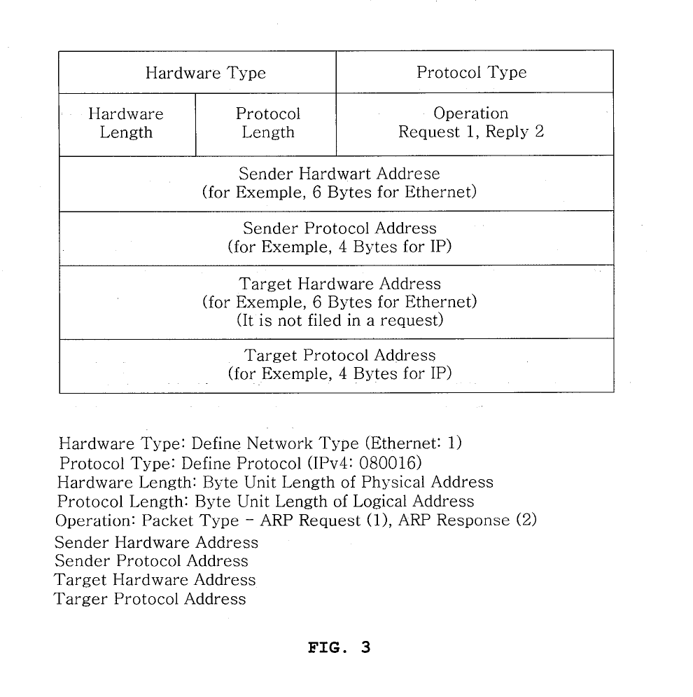

An ARP packet according to the preferred embodiment of the present invention has a structure as illustrated in FIG. 3. The ARP packet may be largely classified as a broadcast packet or a unicast packet. The broadcast packet is transmitted to all devices on a LAN, and the ARP packet has a destination address of FF:FF:FF:FF:FF:FF. However, the unicast packet is transmitted only to a specific device, and this packet has the MAC and IP of the specific device as a destination address. Hereinafter, the broadcast packet will be expressed by BRD (a sender IP, a sender MAC, a receiver IP and a receiver MAC), and the unicast packet will be expressed by UNI (a sender IP, a sender MAC, a receiver IP and a receiver MAC), and the FF:FF:FF:FF:FF:FF will be abbreviated to FF.

In table 1, for example, when the DEV-5 is switched from a power off state to a power on state, all devices check an IP state before using their own IP addresses in order to determine if other devices use the IP addresses. Herein, a hello packet of the ARP packet is used, and has a structure of BRD (IP-5, MAC-5, IP-5 and FF). If another device within the LAN is using the IP-5, said another device sends a response for the hello packet. However, referring to table 1, since no device uses the IP-5, no device sends a response for the hello packet. Accordingly, the DEV-5 can use the IP-5. If the DEV-5 transmits a BRD packet (IP-5, MAC-5, IP-5 and FF), the ARP caches of all devices on the LAN change as illustrated in table 2.

TABLE 2

| Device name | Content (IP and MAC address) of ARP cache |
|---|---|
| DEV-1 | (IP-5, MAC-5) |
| DEV-2 | (IP-5, MAC-5) |
| DEV-3 | (IP-5, MAC-5) |
| DEV-4 | (IP-5, MAC-5) |
| DEV-5 | |
| DEV-P | (IP-5, MAC-5) |

In the meantime, if the DEV-5 transmits an ARP packet indicating that the DEV-5 uses the IP-3 instead of the IP-5, an IP collision occurs between the DEV-5 and the DEV-3. That is, if the DEV-5 transmits a BRD hello packet (IP-3, MAC-5, IP-3 and FF) for IP use, this packet is transferred to all devices on the LAN. Herein, the DEV-3 transmits a response packet UNI (IP-3, MAC-3, IP-3 and MAC-5) to the DEV-5 in response to the BRD hello packet. Then, the DEV-5 confirms the response packet and does not use the IP-3. Herein, since the response packet UNI (IP-3, MAC-3, IP-3 and MAC-5) corresponds to a unicast packet and is transmitted only to the DEV-5, other devices cannot confirm the packet. Accordingly, the ARP caches of each device up to now are as illustrated in table 3 below.

TABLE 3

| Device name | Content (IP and MAC address) of ARP cache |
|---|---|
| DEV-1 | (IP-3, MAC-5) |
| DEV-2 | (IP-3, MAC-5) |
| DEV-3 | |
| DEV-4 | (IP-3, MAC-5) |
| DEV-5 | (IP-3, MAC-3) |
| DEV-X | (IP-3, MAC-5) |

Referring to table 3, since the remaining devices except for the DEV-5 are aware of the MAC of the IP-3 as the MAC-5, communication cannot be accomplished between the DEV-3 and other devices. If the DEV-3 corresponds to a server for performing an important function, much damage may also occur. Since such situations may frequently occur in a network environment while a manager is not also aware of the situations, the IP management device 108 according to the preferred embodiment of the present invention performs an IP protection function.

In order to perform an IP protection function according to a first preferred embodiment of the present invention, a manager must perform protection setup for a corresponding IP. A method for performing the protection setup is to designate an MAC capable of the corresponding IP. That is, remaining MACs except for the designated MAC are prohibited from using the corresponding IP. The packet controller 202 of the IP management device 108 according to the preferred embodiment of the present invention extracts the sender address from the ARP packet transmitted on the network, and determines if the transmission IP address of the sender address has been set as a protection IP. When the transmission IP address has been set as the protection IP, the packet controller 202 determines if the transmission MAC address of the sender address is equal to the designated MAC address capable of the transmission IP address. When the transmission MAC address is different from the designated MAC address, the packet controller 202 transmits an ARP packet, in which the transmission IP address is manipulated as having been already used, to the sender address. In such a case, as illustrated in table 3, since other devices on the LAN mistake an MAC, which has been used in the corresponding IP, as a sender MAC address, the packet controller 202 of the IP management device 108 according to the preferred embodiment of the present invention transmits a compensation packet to all devices on the network. The compensation packet allows the actually used MAC address of the transmission IP address to be equal to the designated MAC address.

Further, according to the preferred embodiment of the present invention, it is possible to reduce network traffic load by suppressing packet transmission from an unauthorized device, as well as the IP protection processing according to the first preferred embodiment of the present invention. That is, a second preferred embodiment of the present invention discloses an invention for forging an ARP cache so that a device, which is to be blocked, mistakes information on other IPs as the third MAC address (or its own MAC address). Further, a third preferred embodiment of the present invention discloses an invention, in which, only for the IP of a main device to be protected, MAC information is blocked to be mistaken as the third MAC address (or its own MAC address), so that such a blocking function can operate only for the main device set by a manager.

To this end, the packet controller 202 of the IP management device 108 according to the second preferred embodiment of the present invention extracts a sender address and/or a receiver address from the ARP packet detected by the packet detector 200, and determines if a sender is an object to be blocked. When the sender is the object to be blocked, the packet controller 202 transmits a blocking packet, in which the transmission MAC address of the sender has been manipulated, in a broadcast manner, and transmits a blocking packet, in which the reception MAC address of the receiver address has been manipulated, to the sender address in a unicast manner. Further, the packet controller 202 determines if a receiver is an object to be blocked. When the receiver is the object to be blocked, the packet controller 202 transmits a blocking packet, in which the reception MAC address of the receiver has been manipulated, in a broadcast or unicast manner, and transmits a blocking packet, in which the transmission MAC address of the sender address has been manipulated, to the receiver address in a unicast manner.

Further, according to the second preferred embodiment of the present invention, not only the reception IP address and normal reception MAC address of the receiver address when the sender is an object to be blocked, but also the transmission IP address and normal transmission MAC address of the sender address when the receiver is an object to be blocked are stored in a blocking transmission list. When a blocking release request is received from the packet controller 202, the blocking release unit 204 according to the second preferred embodiment of the present invention designates objects to be blocked as senders, and transmits a blocking release broadcast packet. Then, the blocking release unit 204 designates the addresses stored in the blocking transmission list as senders, designates objects to be blocked as receivers, and transmits a blocking release unicast packet according to objects to be blocked.

In the meantime, the packet controller 202 of the IP management device 108 according to the third preferred embodiment of the present invention extracts a sender address and/or a receiver address from the ARP packet detected by the packet detector 200, and determines if a sender is an object to be blocked. When the sender is the object to be blocked, the packet controller 202 transmits a blocking packet, in which the transmission MAC address of the sender has been manipulated, in a broadcast manner, and determines if a receiver is a main device. When the receiver is the main device, and transmits a blocking packet, in which the reception MAC address of the receiver address has been manipulated, to the sender address in a unicast manner. Further, the packet controller 202 determines if the receiver is an object to be blocked. When the receiver is the object to be blocked, the packet controller 202 transmits a blocking packet, in which the reception MAC address of the receiver address has been manipulated, in a broadcast or unicast manner, and determines if the sender is a main device. When the sender is the main device, the packet controller 202 transmits a blocking packet, in which the transmission MAC address of the sender address has been manipulated, to all blocked devices on the network in a unicast manner.

Further, according to the third preferred embodiment of the present invention, the reception IP address and normal reception MAC address of the receiver address when the receiver is a main device, the reception IP address and normal reception MAC address of the receiver address when the receiver is an object to be blocked, the transmission IP address and normal transmission MAC address of the sender address when the sender is a main device are stored in a blocking transmission list. When a blocking release request is received from the packet controller 202, the blocking release unit 204 designates objects to be blocked as senders, and transmits a blocking release broadcast packet. Then, the blocking release unit 204 designates the addresses stored in the blocking transmission list as senders, designates objects to be blocked as receivers, and transmits a blocking release unicast packet according to objects to be blocked.

Herein, when the main device according to the third preferred embodiment of the present invention corresponds to a gateway, all packets of an object to be blocked cannot be transferred to other areas through the gateway designated as the main device. Since the gateway is a function unit for interconnecting different types of two or more communication networks (areas) or the same type of two or more communication networks (areas), and enabling information to be exchanged among the communication networks, if the third preferred embodiment of the present invention is used, when a specific communication network has been infected with viruses, it is possible to prevent the corresponding viruses from being transferred to other areas through the gateway. To this ends, the IP management device 108 according to the third preferred embodiment of the present invention may also designate the gateway as a default main device.

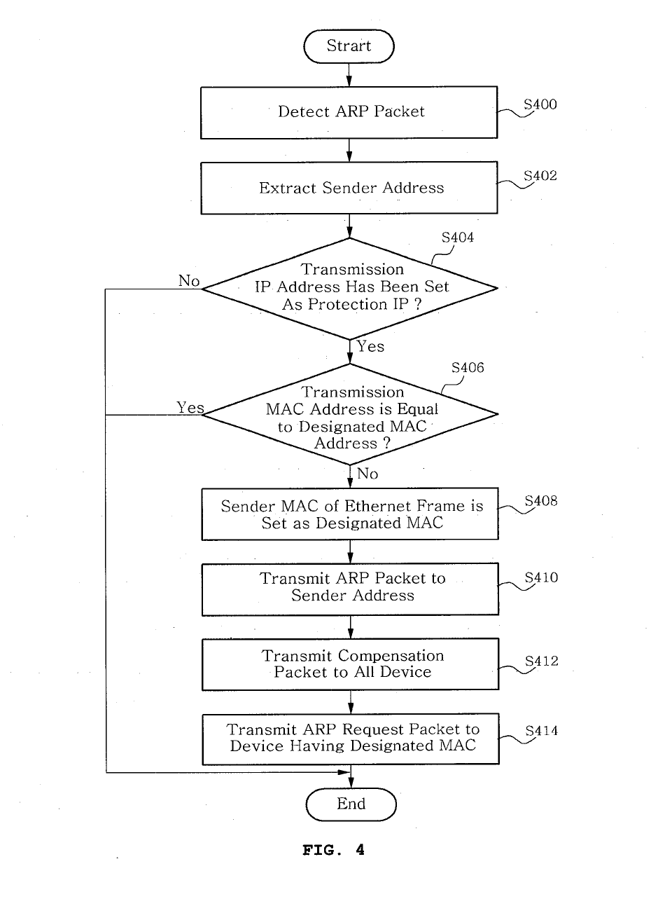

FIG. 4 is a flow diagram illustrating an IP management process for protecting a specific IP address on a network according to the first preferred embodiment of the present invention.

First, the packet detector 200 of the IP management device 108 according to the preferred embodiment of the present invention detects ARP packets transmitted on the network (S400). That is, the packet detector 200 detects the ARP packets transmitted from each device on a LAN. This packet modifies the MAC of a corresponding IP in an ARP cache of another device on the LAN into a sender MAC as illustrated in table 2 or 3.

Next, the packet controller 202 extracts a sender address (IP and MAC) from the detected ARP packet (S402), and determines if the transmission IP address of a sender address has been set as a protection IP (S404). As a result of determination in step 404, when the transmission IP address has been set as the protection IP, the packet controller 202 determines if the transmission MAC address of the sender address is equal to a designated MAC address capable of using the transmission IP address (S406). If the transmission MAC address is equal to the designated MAC address, there is no problem because the designated MAC address normally uses the corresponding IP. However, when the transmission MAC address is different from the designated MAC address, it is necessary to prohibit the use of a sender in order to protect the designated IP. Further, when the designated MAC address is being used, exact compensation procedure is necessary because IP collision generally occurs.

As a result of determination in step 406, when the transmission MAC address is different from the designated MAC address, the packet controller 202 sets the sender MAC of an Ethernet frame as the designated MAC (S408). This is for harmonizing the routing table of the switch 104 with a CAM table. When the MAC of a corresponding IP is different from an actual MAC in the routing table, the switch 104 performs broadcast in order to find a normal MAC. Therefore, the network may be overloaded. Accordingly, step 408 is performed. Specifically, in a state in which the designated MAC is in an off state, it is impossible to obtain an effect in the following step 414. In such a case, step 408 is more meaningful. However, this step is not a necessary step, and may be omitted if the situation requires.

Then, the packet controller 202 transmits an ARP packet, in which the transmission IP address is manipulated as having been already used, to the sender address (S410). That is, in order to prohibit the use of the sender intended for the use of the designated IP, the packet controller 202 transmits a UNI packet (a sender IP, a fixed MAC, a sender IP and a sender MAC) to the sender address. The sender having received the UNI packet mistakes that there is a device using the corresponding IP, and forgives the use of the corresponding IP. As a result, an IP collision message pops up on the screen of the sender.

Then, the packet controller 202 transmits a compensation packet to all devices on the network, wherein the compensation packet allows the actually used MAC address of the transmission IP address to be equal to the designated MAC address (S412). Referring to the results up to step 410, other devices on the LAN mistake the MAC used in the corresponding IP as the sender MAC as illustrated in table 3. Therefore, problems may occur in the network use of the designated MAC. Accordingly, it is necessary to transmit a packet for solving the problems to the LAN in order for the designated MAC to normally use the network. This packet may be individually transmitted to all devices in a unicast manner. Further, for convenience of accomplishment, the packet may be transmitted in a broadcast manner. In other words, the IP management device 108 transmits a BRD (a sender IP, a fixed MAC, a sender IP and an FF), thereby allowing the actually used MAC of the IP to be equal to the designated MAC in the ARP caches of all devices.

In an additional step, the IP management device 108 transmits an ARP request packet, in which the IP management device 108 is designated as a sender and a device having the designated MAC is designated as a receiver, so that port information within the MAC table of the switch 104 is corrected (S414).

Since the compensation packet in step 412 is transmitted from the IP management device 108, the port number of the device having the designated MAC is stored as a port number, in which the IP management device 108 exists, in the MAC table of the switch 104. In this way, since packets, which must be transmitted to a port connected to the device having the designated MAC, are transmitted to a port connected to the IP management device 108, a problem such as communication interruption may occur. That is, since confusion may occur in MAC addresses of devices connected to ports in the switch 104, the ARP request packet UNI (a management device IP, a management device MAC, a sender IP and a sender MAC) is transmitted for normal communication of the designated MAC, so that a response to the device having the designated MAC is obtained.

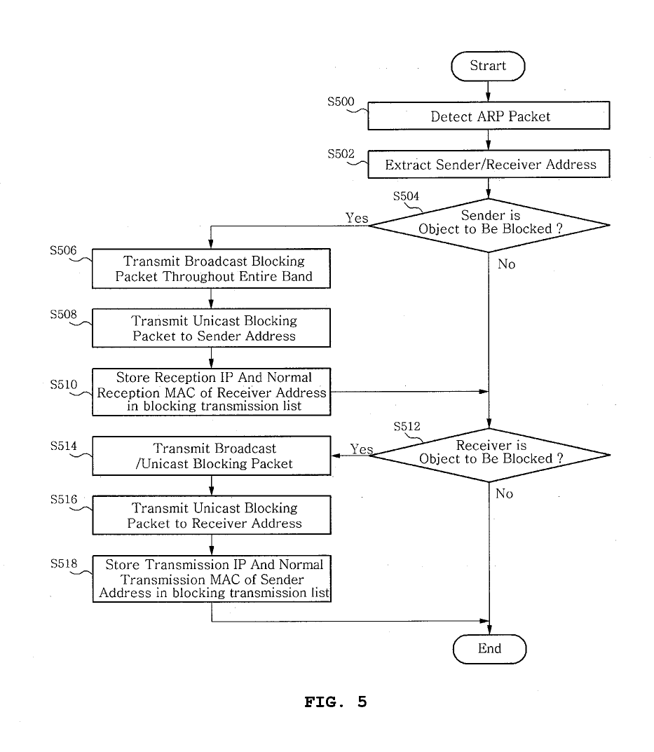

FIG. 5 is a flow diagram illustrating an IP management process for blocking a specific device having a specific IP address on a network according to the second preferred embodiment of the present invention.

As described above, according to the second preferred embodiment of the present invention, a blocked device unconditionally mistakes the MAC of another device as its own MAC, transmission/reception addresses are searched for from all APR packets outputted from the device, and blocking control is performed.

First, the packet detector 200 of the IP management device 108 according to the preferred embodiment of the present invention detects ARP packets transmitted on the network (S500). That is, the packet detector 200 detects the ARP packets transmitted from each device on a LAN. This packet modifies the MAC of a corresponding IP in an ARP cache of another device on the LAN into a sender MAC as illustrated in table 2 or 3. Next, the packet controller 202 extracts sender/receiver addresses (IP and MAC) from the detected ARP packet (S502).

The IP management device 108 according to the preferred embodiment of the present invention determines if a sender is an object to be blocked (S504). When the sender is the object to be blocked, the IP management device 108 transmits a blocking packet, in which the transmission MAC address of the sender has been manipulated, in a broadcast manner (S506). For example, the IP management device 108 transmits a broadcast blocking packet BRD (a sender IP, an MAC-P, a sender IP and an FF) throughout the entire band. Accordingly, other devices except for the sender mistake the sender IP as a control device MAC “MAC-P” through the packet due to change in the content of an ARP cache, and thus communication between said other devices and the sender is blocked.

Then, the IP management device 108 transmits a blocking packet, in which the reception MAC address of a receiver address has been manipulated, to a sender address in a unicast manner (S508). For example, the IP management device 108 transmits a unicast packet UNI (a receiver IP, a sender MAC, a sender IP and a sender MAC) to the sender address. This packet allows the address of the receiver, which the sender wants to know, to be altered to the MAC of the sender. Herein, the IP management device 108 stores the reception IP address and normal reception MAC address of the receiver address in a blocking transmission list (S510) This is for a blocking release process that will be described later.

Then, the IP management device 108 determines if the receiver is an object to be blocked (S512). When the receiver is the object to be blocked, the IP management device 108 transmits a blocking packet, in which the reception MAC address of the receiver has been manipulated, in a broadcast or unicast manner (S514). For example, the IP management device 108 transmits a broadcast blocking packet BRD (a sender IP, an MAC-P, a sender IP and an FF) throughout the entire band, or transmits a unicast blocking packet UNI (a receiver IP, an MAC-P, a sender IP and a sender MAC) to the sender address. Herein, the detected packet is a packet for allowing the sender to normally recognize the MAC of the receiver, which is the object to be blocked. Accordingly, the IP management device 108 transmits the manipulated packet for return to the blocking state.

Further, the IP management device 108 transmits a blocking packet, in which the transmission MAC address of the sender address has been manipulated, to the receiver address in a unicast manner (S516). The packet detected in step 500 allows the MAC address of the sender to normally change in the ARP cache of the receiver that is the object to be blocked. Accordingly, as in step 508, the IP management device 108 transmits a unicast blocking packet UNI (a sender IP, a receiver MAC, a receiver IP and a receiver MAC) in order to prevent a packet from being transmitted from the receiver that is the object to be blocked to other devices. Herein, the IP management device 108 stores the transmission IP address and normal transmission MAC address of the sender address in the blocking transmission list (S518). This is for the blocking release process that will be described later.

In the meantime, in order to release the blocking state of the devices blocked in the afore-described process, it is necessary to allow the ARP caches of devices within the network, which have been abnormally manipulated due to the blocking, to return to a normal state. Hereinafter, the blocking release process will be described.

When a blocking release request exists, the blocking release unit 204 designates an object to be blocked as a sender, and transmits a blocking release broadcast packet. Herein, the blocking release broadcast packet may have a BRD format (a blocking IP, a blocking MAC, an MAC-IP and an FF). In step 510 and/or 518, the blocking release unit 204 designates the address stored in the blocking transmission list as a sender, designates an object to be blocked as a receiver, and transmits a blocking release unicast packet. Herein, the blocking release unicast packet may have a UNI format (a list IP, a list MAC, a blocking IP and a blocking MAC). This packet is transmitted by the number of IPs within the blocking transmission list, which are stored according to blocked IPs. In an additional step, the IP management device 108 transmits an ARP request packet, in which the IP management device 108 is designated as a sender and a device to be blocked is designated as a receiver, so that port information within the MAC table of the switch 104 is corrected. Herein, the ARP request packet may have a UNI format (an IP-P, an MAC-P, a blocking IP and a blocking MAC). The meaning of this step is as described in step 414.

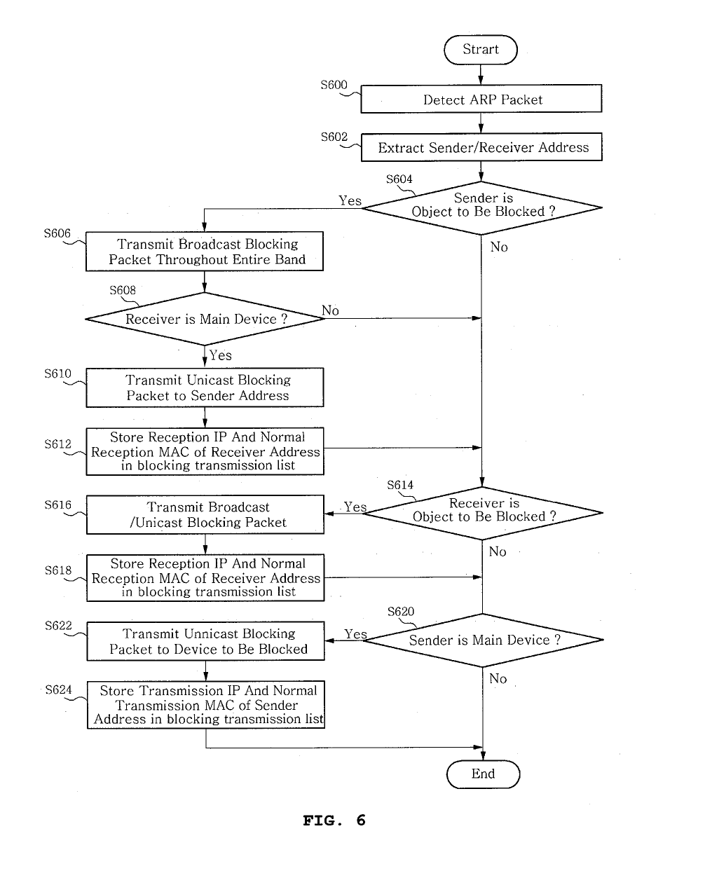

FIG. 6 is a flow diagram illustrating an IP management process for blocking a specific device having a specific IP address on a network, and blocking transmission to a main device designated by a manager according to the third preferred embodiment of the present invention.

As described above, according to the third preferred embodiment of the present invention, access control is not performed for all devices within the network, but information is manipulated only for a main device designated by a manager.

First, the packet detector 200 of the IP management device 108 according to the preferred embodiment of the present invention detects ARP packets transmitted on the network (S600). That is, the packet detector 200 detects the ARP packets transmitted from each device on a LAN. This packet modifies the MAC of a corresponding IP in an ARP cache of another device on the LAN into a sender MAC as illustrated in table 2 or 3. Next, the packet controller 202 extracts sender/receiver addresses (IP and MAC) from the detected ARP packet (S602).

The IP management device 108 according to the preferred embodiment of the present invention determines if a sender is an object to be blocked (S604). When the sender is the object to be blocked, the IP management device 108 transmits a blocking packet, in which the transmission MAC address of the sender has been manipulated, in a broadcast manner (S606). For example, the IP management device 108 transmits a broadcast blocking packet BRD (a sender IP, an MAC-P, a sender IP and an FF) throughout the entire band. Accordingly, other devices except for the sender mistake the sender IP as a control device MAC “MAC-P” through the packet due to change in the content of an ARP cache, and thus communication between said other devices and the sender is blocked.

Then, the IP management device 108 determines if a receiver is the main device designated by the manager (S608) When the receiver is the main device, the IP management device 108 transmits a blocking packet, in which the reception MAC address of a receiver address has been manipulated, to a sender address in a unicast manner (S610). Herein, the blocking packet may have a UNI format (a main device IP, a sender MAC, a sender IP and a sender MAC). This packet allows the address of the receiver, which the sender wants to know, to be altered to the MAC of the sender, and is similar to that of the second embodiment. However, the packet is transmitted to the sender address by the number of main devices existing in the LAN. That is, the packet allows the MAC addresses of all main devices existing in the LAN to be altered to the MAC of the sender. Herein, the IP management device 108 stores the reception IP address and normal reception MAC address of the receiver address in a blocking transmission list (S612). This is for a blocking release process that will be described later.

Then, the IP management device 108 determines if the receiver is an object to be blocked (S614). When the receiver is the object to be blocked, the IP management device 108 transmits a blocking packet, in which the reception MAC address of the receiver has been manipulated, in a broadcast or unicast manner (S616). For example, the IP management device 108 transmits a broadcast blocking packet BRD (a receiver IP, an MAC-P, a sender IP and an FF) throughout the entire band, or transmits a unicast blocking packet UNI (a receiver IP, an MAC-P, a sender IP and a sender MAC) to the sender address. Herein, the detected packet is a packet for allowing the sender to normally know the MAC of the receiver, which is the object to be blocked. Accordingly, the IP management device 108 transmits the manipulated packet for return to the blocking state. Herein, the IP management device 108 stores the reception IP address and normal reception MAC address of the receiver address in the blocking transmission list (S618). This is for the blocking release process that will be described later.

Further, the IP management device 108 determines if the sender is the main device designated by the manager (S620). When the sender is the main device, the IP management device 108 transmits a blocking packet, in which the transmission MAC address of the sender address has been manipulated, to the receiver address of the device to be blocked in a unicast manner (S622). Herein, the blocking packet may have a UNI format (a main device IP, a blocked device MAC, a blocked device IP and a blocked device MAC). This packet is transmitted to all blocked devices within the network, and changes the address of the sender, i.e. the main device address, to the MAC of the blocked device. Herein, the IP management device 108 stores the transmission IP address and normal transmission MAC address of the sender address in the blocking transmission list (S624). This is for the blocking release process that will be described later.

In the meantime, in order to release the blocking state of the devices blocked in the afore-described process, it is necessary to allow the ARP caches of devices within the network, which have been abnormally manipulated due to the blocking, to return to a normal state. Hereinafter, the blocking release process will be described.

When a blocking release request exists, the blocking release unit 204 designates an object to be blocked as a sender, and transmits a blocking release broadcast packet. Herein, the blocking release broadcast packet may have a BRD format (a blocking IP, a blocking MAC, an MAC-IP and an FF). In step 612, 618 and/or 624, the blocking release unit 204 designates the address stored in the blocking transmission list as a sender, designates an object to be blocked as a receiver, and transmits a blocking release unicast packet. Herein, the blocking release unicast packet may have a UNI format (a list IP, a list MAC, a blocking IP and a blocking MAC). This packet is transmitted by the number of IPs within the blocking transmission list, which are stored according to blocked IPs. In an additional step, the IP management device 108 transmits an ARP request packet, in which the IP management device 108 is designated as a sender and a device to be blocked is designated as a receiver, so that port information within the MAC table of the switch 104 is corrected. Herein, the ARP request packet may have a UNI format (an IP-P, an MAC-P, a blocking IP and a blocking MAC) The meaning of this step is as described in step 414.

While this invention has been described in connection with what is presently considered to be the most practical and preferred embodiment, it is to be understood that the present invention is not limited to the disclosed embodiment and the drawings, but, on the contrary, it is intended to cover various modifications and variations within the spirit and scope of the appended claims.

### INDUSTRIAL APPLICABILITY

According to the present invention as described above, IPs, which are used by main devices such as main servers, web servers and DB servers on a network, are set as a protection IP, and other devices are prohibited from using the protection IP, so that it is possible to protect a specific IP. Further, according to the present invention, an unauthorized (blocked) device is fundamentally prohibited from accessing systems or devices having been set as main devices, so that the amount of network traffic transferred to the main device can be minimized. As a result, it is possible to prevent the performance of the main devices from deteriorating.

Furthermore, functions according to the present invention can be performed regardless of whether an MAC fixed to a protection IP is in an on state or an off state. That is, even when the fixed MAC is in an off state, another MAC is prohibited from using the protection IP. Consequently, when the fixed MAC is switched to an on state, it is possible to use the corresponding IP with no problem.

1. An Internet Protocol (IP) management method for protecting a specific IP address on a network, the method comprising the steps of:
(a) detecting an Address Resolution Protocol (ARP) packet transmitted on the network;
(b) extracting a sender address from the ARP packet;
(c) determining if a transmission IP address of the sender address has been set as a protection IP;
(d) when the transmission IP address has been set as the protection IP, determining if a transmission Media Access Control (MAC) address of the sender address is equal to a designated MAC address capable of using the transmission IP address;
(e) when the transmission MAC address is different from the designated MAC address, transmitting an ARP packet, in which the transmission IP address is manipulated as having been already used, to the sender address; and
(f) transmitting a compensation packet to all devices on the network, wherein the compensation packet allows an actually used MAC address of the transmission IP address to be equal to the designated MAC address.

2. The method as claimed in claim 1, wherein, in step (e), a sender MAC of an Ethernet frame is set as the designated MAC address of the manipulated ARP packet.

3. The method as claimed in claim 1, further comprising a step of, after step (f), transmitting an ARP request packet, in which an IP management device is designated as a sender and a device having the designated MAC is designated as a receiver, thereby allowing port information within an MAC table of a switch to be corrected.

4. An IP management method for protecting a specific device having a specific IP address on a network, the method comprising the steps of:
(a) detecting an ARP packet transmitted on the network;
(b) extracting a sender address and/or a receiver address from the ARP packet;
(c) determining if a sender is an object to be blocked, transmitting a blocking packet, in which a transmission MAC address of the sender has been manipulated, in a broadcast manner when the sender is the object to be blocked; and
(d) transmitting a blocking packet, in which a reception MAC address of the receiver address has been manipulated, to the sender address in a unicast manner.

5. The method as claimed in claim 4, further comprising the steps of:
(e) determining if a receiver is an object to be blocked, transmitting a blocking packet, in which a reception MAC address of the receiver has been manipulated, in a broadcast manner when the receiver is the object to be blocked; and
(f) transmitting a blocking packet, in which a transmission MAC address of the sender address has been manipulated, to the receiver address in a unicast manner.

6. The method as claimed in claim 4, further comprising the steps of:
(e1) determining if a receiver is an object to be blocked, transmitting a blocking packet, in which a reception MAC address of the receiver has been manipulated, to the sender address in a unicast manner when the receiver is the object to be blocked; and
(f1) transmitting a blocking packet, in which a transmission MAC address of the sender address has been manipulated, to the receiver address in a unicast manner.

7. The method as claimed in claim 5, further comprising the steps of:
(g) storing both a reception IP address and a normal reception MAC address of the receiver address of step (d), and a transmission IP address and a normal transmission MAC address of the sender address, when the receiver is the object to be blocked, in a blocking transmission list;
(h) when a blocking release request exists, designating the objects to be blocked as senders, and transmitting a blocking release broadcast packet; and
(i) designating the addresses stored in the blocking transmission list as senders, designating the object to be blocked as a receiver, and transmitting a blocking release unicast packet according to the objects to be blocked.

8. The method as claimed in claim 4, further comprising, after step (d), the steps of:
(g1) storing a reception IP address and a normal reception MAC address of the receiver address of step (d) in a blocking transmission list;
(h1) when a blocking release request exists, designating the objects to be blocked as senders, and transmitting a blocking release broadcast packet; and
(i1) designating the addresses stored in the blocking transmission list as senders, designating the object to be blocked as a receiver, and transmitting a blocking release unicast packet according to the objects to be blocked.

9. The method as claimed in claim 7, further comprising, after step (i), the steps of transmitting an ARP request packet, in which an IP management device is designated as a sender and the objects to be blocked is designated as receivers, thereby allowing port information within an MAC table of a switch to be corrected.

10. An IP management method blocking a specific device having a specific IP address on a network, and blocking transmission to a main device designated by a manager, the method comprising the steps of:
(a) detecting an ARP packet transmitted on the network;
(b) extracting a sender address and/or a receiver address from the ARP packet;
(c) determining if a sender is an object to be blocked, transmitting a blocking packet, in which a transmission MAC address of the sender has been manipulated, in a broadcast manner when the sender is the object to be blocked; and
(d) determining if a receiver is a main device, and transmitting a blocking packet, in which a reception MAC address of the receiver address has been manipulated, to the sender address in a unicast manner when the receiver is the main device.

11. The method as claimed in claim 10, further comprising the steps of:
(e) determining if the receiver is an object to be blocked, transmitting a blocking packet, in which the reception MAC address of the receiver address has been manipulated, in a broadcast manner when the receiver is the object to be blocked; and
(f) determining if the sender is the main device, transmitting a blocking packet, in which the transmission MAC address of the sender address has been manipulated, to all blocked devices on the network in a unicast manner when the sender is the main device.

12. The method as claimed in claim 10, further comprising the steps of:
(e1) determining if the receiver is an object to be blocked, transmitting a blocking packet, in which the reception MAC address of the receiver address has been manipulated, in a unicast manner when the receiver is the object to be blocked; and
(f1) determining if the sender is the main device, transmitting a blocking packet, in which the transmission MAC address of the sender address has been manipulated, to all blocked devices on the network in a unicast manner when the sender is the main device.

13. The method as claimed in claim 11, further comprising the steps of:
(g) storing both a reception IP address and a normal reception MAC address of the receiver address when the receiver is the main device or the receiver is the object to be blocked, and a transmission IP address and a normal transmission MAC address of the sender address, when the sender is the main device, in a blocking transmission list;
(h) when a blocking release request exists, designating the objects to be blocked as senders, and transmitting a blocking release broadcast packet; and
(i) designating the addresses stored in the blocking transmission list as senders, designating the object to be blocked as a receiver, and transmitting a blocking release unicast packet according to the objects to be blocked.

14. The method as claimed in claim 10, further comprising, after step (d), the steps of:
(g1) storing both a reception IP address and a normal reception MAC address of the receiver address of step (d) in a blocking transmission list;
(h1) when a blocking release request exists, designating the objects to be blocked as senders, and transmitting a blocking release broadcast packet; and
(i1) designating the addresses stored in the blocking transmission list as senders, designating the object to be blocked as a receiver, and transmitting a blocking release unicast packet according to the objects to be blocked.

15. The method as claimed in claim 13, further comprising, after step (i), the steps of transmitting an ARP request packet, in which an IP management device is designated as a sender and the objects to be blocked is designated as receivers, thereby allowing port information within an MAC table of a switch to be corrected.

16. An IP management apparatus for protecting a specific IP address on a network, the apparatus comprising:
a packet detector for detecting an ARP packet transmitted on the network; and
a packet controller for extracting a sender address from the ARP packet, determining if a transmission IP address of the sender address has been set as a protection IP, determining if a transmission MAC address of the sender address is equal to a designated MAC address capable of using the transmission IP address when the transmission IP address has been set as the protection IP, transmitting an ARP packet, in which the transmission IP address is manipulated as having been already used, to the sender address when the transmission MAC address is different from the designated MAC address, and transmitting a compensation packet to all devices on the network, wherein the compensation packet allows an actually used MAC address of the transmission IP address to be equal to the designated MAC address.

17. An IP management apparatus for blocking a specific device having a specific IP address on a network, the apparatus comprising:
a packet detector detecting an ARP packet transmitted on the network; and
a packet controller for extracting a sender address and/or a receiver address from the ARP packet, determining if a sender is an object to be blocked, transmitting a blocking packet, in which a transmission MAC address of the sender has been manipulated, in a broadcast manner when the sender is the object to be blocked, transmitting a blocking packet, in which a reception MAC address of the receiver address has been manipulated, to the sender address in a unicast manner, determining if a receiver is an object to be blocked, transmitting a blocking packet, in which a reception MAC address of the receiver has been manipulated, in a broadcast/unicast manner when the receiver is the object to be blocked, and transmitting a blocking packet, in which the transmission MAC address of the sender address has been manipulated, to the receiver address in a unicast manner.

18. The apparatus as claimed in claim 17, further comprising a blocking release unit for storing both a reception IP address and a normal reception MAC address of the receiver address when the sender is the object to be blocked, and a transmission IP address and a normal transmission MAC address of the sender address, when the receiver is the object to be blocked, in a blocking transmission list, designating the objects to be blocked as senders and transmitting a blocking release broadcast packet when a blocking release request exists, designating the addresses stored in the blocking transmission list as senders, designating the object to be blocked as a receiver, and transmitting a blocking release unicast packet according to the objects to be blocked.

19. An IP management apparatus blocking a specific device having a specific IP address on a network, and blocking transmission to a main device designated by a manager, the apparatus comprising:
a packet detector detecting an ARP packet transmitted on the network; and
a packet controller for extracting a sender address and/or a receiver address from the ARP packet, determining if a sender is an object to be blocked, transmitting a blocking packet, in which a transmission MAC address of the sender has been manipulated, in a broadcast manner when the sender is the object to be blocked, determining if a receiver is a main device, transmitting a blocking packet, in which a reception MAC address of the receiver address has been manipulated, to the sender address in a unicast manner when the receiver is the main device, determining if the receiver is an object to be blocked, transmitting a blocking packet, in which the reception MAC address of the receiver address has been manipulated, in a broadcast/unicast manner when the receiver is the object to be blocked, and determining if the sender is the main device, transmitting a blocking packet, in which the transmission MAC address of the sender address has been manipulated, to all blocked devices on the network in a unicast manner when the sender is the main device.

20. The apparatus as claimed in claim 19, further comprising a blocking release unit for storing both a reception IP address and a normal reception MAC address of the receiver address when the receiver is the main device or the receiver is the object to be blocked, and a transmission IP address and a normal transmission MAC address of the sender address, when the sender is the main device, in a blocking transmission list, designating the objects to be blocked as senders and transmitting a blocking release broadcast packet when a blocking release request exists, designating the addresses stored in the blocking transmission list as senders, designating the object to be blocked as a receiver, and transmitting a blocking release unicast packet according to the objects to be blocked.
